(19) United States
(12) Patent Application Publication
(10) Pub. No.: US 2004/0140105 A1
(43) Pub. Date: Jul. 22, 2004

(54) Combustion supression system

(76) Inventor: Changize Sadr, North York (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/681,340

(22) Filed: Oct. 9, 2003

Related U.S. Application Data
(60) Provisional application No. 60/417,144, filed on Oct. 10, 2002.

(51) Int. Cl. A62C 35/02

(52) U.S. Cl. 169/62; 169/66; 169/26

(57) ABSTRACT

The present invention provides a combustion suppressing cartridge for attachment to the outer surface of a fuel tank. The cartridge has a casing which surrounds a cavity. A quantity of combustion suppressing material is provided in the cavity. The casing is sized and shaped so that a plurality of cartridges may be affixed in a scattered arrangement to the outer surface of the fuel tank. The cartridges may be affixed to the fuel tank before installation or as a retrofit, to an installed fuel tank without need to remove the tank.

### FIELD OF THE INVENTION

The present invention relates to systems for suppressing combustion, particularly in relation to fuel tanks of vehicles involved in accidents.

### BACKGROUND OF THE INVENTION

Accidents involving motor vehicles may cause serious injury to occupants, particularly if the fuel tank is damaged. Damage to the fuel tank, either by being crushed within the vehicle itself or by being ruptured by an external object, can result in a fuel leak which may ignite so as to create an intense fuel-fed fire.

Providing devices to offer fire protection in the event of collisions causing fuel tank damage are known in the art. For example, U.S. Pat. No. 5,762,145(Bennett) discloses a powder panel mounted on each face of a fuel tank, wherein the panel contains a fire extinguishing powder, a portion of which is released upon rupture of the panel. However, fuel tanks are generally not simple geometric shapes, and the complexity of the shape combined with limited space around an installed fuel tank in modern vehicles may render the panel of Bennett impractical.

### SUMMARY OF THE INVENTION

It is an object of the invention to improve on the prior art. It is another object of the present invention to provide a combustion suppression cartridge for attachment to a fuel tank, and elements of a combustion suppression system for a fuel tank. A plurality of cartridges may be affixed to a fuel tank before installation, or as a retrofit to an installed fuel tank without need to remove the tank. These and other objects are provided by the features described in the claims. The following summary provides an introduction to the invention which may reside in a combination or sub-combination of features provided in this summary or in other parts of this document.

According to one aspect of the invention, a combustion suppressing cartridge is provided for attachment to the outer surface of a fuel tank. The cartridge has a casing which defines and internal cavity. A quantity of combustion suppressing material is provided in the cavity. The casing is sized and shaped so that a plurality of cartridges may be affixed in a scattered arrangement to the outer surface of the fuel tank.

The casing of the cartridge can be sufficiently tough to withstand loads encountered during normal operating conditions, and sufficiently brittle so that said casing ruptures under severe loads. The casing can be of a generally transparent material. The casing material can include one or more materials selected from the group consisting of mineral filled polypropylene, styrenic polymers, polyvinyl chloride, cellulose acetate, polyesters, and mineral filled formulated polyethylene.

The casing can be formed of a multi-layered parison. The casing can be elongate in shape, and can be generally rectangular in cross-section, having a cross-sectional thickness that is less than the cross-sectional width. The casing can alternatively have a generally circular cross-section. As a further alternative shape, the casing can be generally disc-shaped. For any shape embodiment, the casing can have a generally flat joint surface to facilitate adhering the cartridge to the fuel tank.

The combustion suppressing material can include at least one of the group consisting of sodium bicarbonate, potassium bicarbonate, potassium chloride, ammonium phosphate, and halon.

According to a second aspect of the present invention, a fuel tank to which a plurality of combustion suppressing cartridges may be attached is provided, The fuel tank has an outer surface and a plurality of recesses provided in a scattered arrangement in said outer surface. Each of the plurality of recesses is sized and shaped to receive at least one of the plurality of combustion suppressing cartridges.

Each recess can have at least one resilient lip adjacent the outer surface of said tank for engaging said at least one cartridge in snap-fit.

According to a third aspect of the invention, a combination of a fuel tank and a plurality of combustion suppressing cartridges is provided. The fuel tank has an outer surface, and each of the plurality of combustion suppressing cartridges includes a casing surrounding a cavity, and a quantity of combustion suppressing material within said cavity. The casing of each cartridge is sized and shaped so that the plurality of cartridges may be affixed, in a scattered arrangement, to the outer surface of the fuel tank.

The outer surface of the fuel tank can be provided with a plurality of recesses, each recess being shaped to receive at least one of the plurality of cartridges. Each recess can have at least one resilient lip adjacent the outer surface of the tank for engaging the casing of the cartridge in snap-fit.

An adhesive can be provided between the casing of each of the cartridges and the outer surface of the fuel tank. The adhesive can include a length of double-sided tape. Each of the cartridges can have a generally flat joint surface, and the adhesive can be positioned between the joint surface and the outer surface of said fuel tank.

### BRIEF DESCRIPTION OF THE DRAWINGS

For a better understanding of the present invention and to show more clearly how it would be carried into effect, reference will now be made by way of example, to the accompanying drawings that show a preferred embodiment of the present invention, and in which:

FIG. 1 is a top perspective view of cartridges in combination with a fuel tank of a combustion suppression system according to the present invention;

FIG. 2 is an enlarged perspective view of one of the cartridges of FIG. 1;

FIG. 3 is a cross-sectional view of the cartridge of FIG. 2, taken along the line 3-3;

FIG. 4 is a bottom perspective view of the system of FIG. 1;

FIG. 5 is a side view of the cartridges of FIG. 1 affixed to a curved surface of a fuel tank;

FIG. 6 is a perspective view of a portion of a cartridge of FIG. 1, showing an adhesive in greater detail;

FIG. 7 is a bottom perspective view of alternative cartridges and a fuel tank of a combustion suppression system according to the present invention;

FIG. 8 is a cross-sectional view of one of the cartridges of FIG. 7, taken along the line 8-8;

FIG. 9 is a top perspective view of the system of FIG. 7; and

FIG. 10 is a perspective view of alternative cartridges and a fuel tank of a combustion suppression system according to the present invention.

### DETAILED DESCRIPTION OF THE INVENTION

A combustion suppression cartridge of the present invention is shown generally at 10 in FIG. 1. A plurality of combustion suppression cartridges may be applied to a fuel tank 12, as will hereinafter be described.

The size and shape of the fuel tank 12 to which the cartridges 10 may be applied is a relevant consideration in determining the size and shape of the cartridges 10. The fuel tank 12, as may typically be provided in a motor vehicle, has a hollow shell 14 which may be of plastic or metal construction. The shell 14 provides an outer surface 16, which will typically have a number of raised portions and depressed portions, generally referred to as contour irregularities 18. Contour irregularities 18 may be provided to facilitate efficient packaging of the fuel tank 12 underneath a vehicle.

Despite the complexity of the outer surface 16 of the fuel tank 12, the outer surface 16 can be generally described as having six faces 21 corresponding to six faces 21 of an imaginary box 20 encompassing the fuel tank 12. The six faces 21 of outer surface 16 so defined are the top face 22, bottom face 24, front face 26, rear face 28, and side faces 30, 32. The height, width, and length dimensions of the fuel tank 12 are 34, 36, and 38, respectively (see FIG. 1).

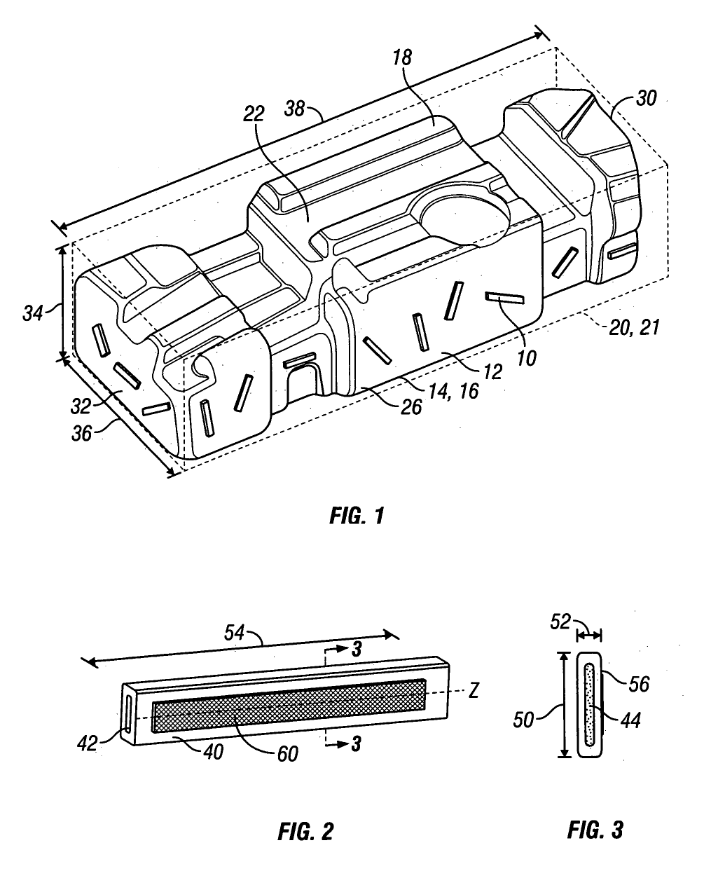

Referring now to FIGS. 2 and 3, the cartridge 10 has a casing 40 that defines and internal cavity 42. A quantity of combustion suppressing material 44 is provided in the cavity 42. The combustion suppressing material 44 may be, for example but not limited to, Sodium Bicarbonate, Potassium Bicarbonate, Potassium Chloride, Ammonium Phosphate, or Halon.

In one embodiment, the casing 40 is of a construction such that the casing 40 is sufficiently tough to withstand impact or other loads which may normally be encountered by the casing 40 when affixed to the fuel tank 12 of a moving vehicle during normal operating conditions. Such loads may be generated by, for example, sudden acceleration or braking, impact of stones or other small objects, and forces generated by relatively minor accidents. However, the casing 40 is sufficiently brittle so that the casing 40 ruptures under severe loads, such as impact forces which may be generated in a more serious accident and in which the fuel tank 12 and affixed cartridges 10 may be crushed or punctured.

In addition to the desired degree of toughness and brittleness of the material of the casing 40, it may be advantageous that the casing 40 be transparent, so that the combustion suppressing material 44 of the cartridge 10 is visible through the casing 40.

The method of manufacturing the cartridge 10 may also be a consideration in selecting a suitable material for casing 40. The casing 40 of the cartridge 10 may advantageously be manufactured by extruding a parison, enclosing the extruded parison in a mold, and then expanding the parison to achieve the desired configuration of the casing 40. Once cooled, the molded product may be cut and trimmed to provide a finished, but unsealed, casing 40, which has an opening providing access to a cavity 42. To complete the manufacture of cartridge 10, an amount of combustion suppressing material 44 may be inserted into the cavity 42 through the opening, and the opening may then be sealed. The opening of the casing 40 may be sealed using, for example but not limited to, a cap secured to the casing 40 around the opening, or by pinching together and thermally welding the material of the casing 40 adjacent the opening.

Depending on the material chosen for the casing 40, it may be desirable to provide enhanced moisture barrier properties in casing 40. This may be desired to protect combustion suppressing material 44 from moisture intrusion into casing 40. Such moisture intrusion may cause a deterioration of the effectiveness of the combustion suppressing cartridge 10. To provide additional moisture barrier properties, a multi-layer parison may be produced and used for forming the casing 40. At least one layer of the multi-layer parison may be of a material providing satisfactory moisture barrier characteristics.

In view of the above considerations, it may be desirable that the material or materials for constructing the casing 40 provide some toughness and some brittleness, be transparent, be suitable for blow moulding and provide a sufficient degree of moisture barrier properties. Possible materials for the construction of the casing 40 may be, for example but not limited to, mineral filled polypropylene, styrenic polymers, polyvinyl chloride, cellulose acetate, polyesters, and formulated polyethylene (mineral filled). One material considered particularly suitable is Salflex® 620-series mineral filled polypropylene produced by Salflex Polymers Limited.

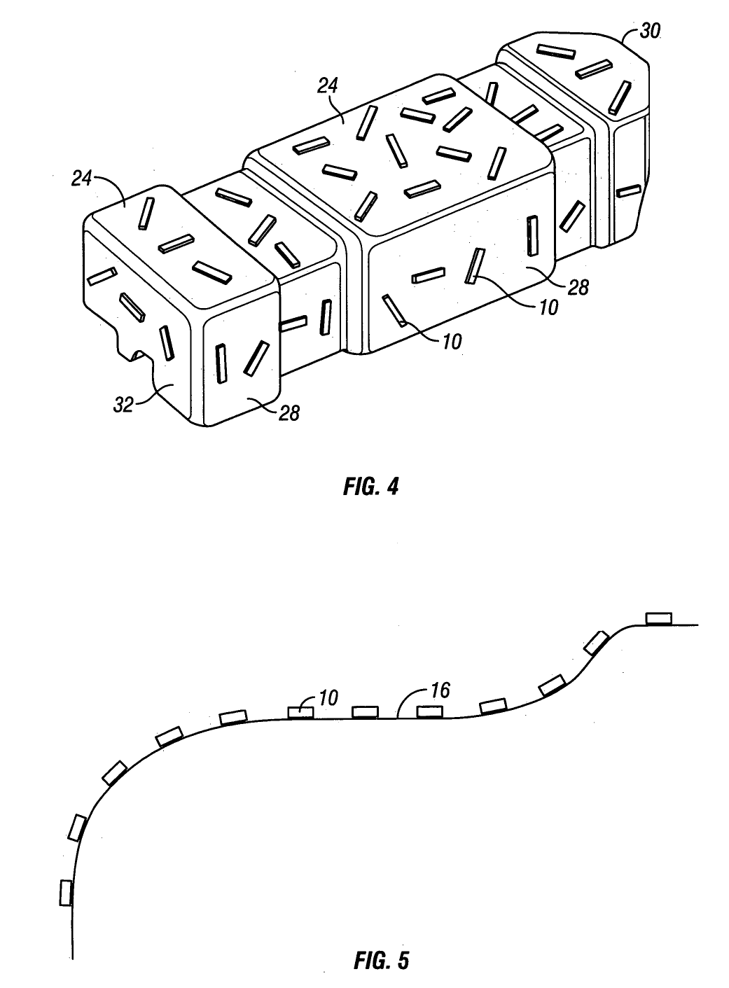

Referring now to FIG. 4, the casing 40 is of a compact size and shape, so that a plurality of cartridges 10 may be affixed, in scattered arrangement, to any one or more of the faces 21 of the outer surface 16 of the fuel tank 12. This enables the attachment of the cartridges 10 to the fuel tank 12 wherever spaces exist between the outer surface 16 of the fuel tank 12 and adjacent vehicle components (not shown).

Referring again to FIGS. 2 and 3, in one embodiment the cartridge 10 is elongate and substantially rectangular in cross-section. The cartridge 10 has a cross-sectional width 50 and thickness 52, and a length 54. The thickness 52 is less than the width 50. Providing a cartridge 10 with a small thickness 52 is desirable so that cartridge 10 may be affixed to the fuel tank 12, as will be described subsequently. The width 50, as well as the length 54, of cartridge 10 are each less than the smallest dimension of the group of fuel tank dimensions consisting of the height 34, width 36, and length 38.

For affixing the cartridges 10 to the fuel tank 12, an adhesive 60 may be provided. In a cartridge 10 affixed to a fuel tank 12, the adhesive 60 is provided between, and adhered to, the casing 40 of cartridge 10 and the outer surface 16 of fuel tank 12. To facilitate providing a satisfactory bond, a substantially flat joint surface 56 is provided on the casing 40 of the cartridge 10. The joint surface 56 provides a high degree of surface contact between the cartridge 10 and the fuel tank 12 along any suitable portion of the outer surface 16 of the fuel tank 12. Good surface contact may be provided along flat portions of the outer surface 16, and along curved profiles of the outer surface 16, provided the radius of curvature is not too small (FIG. 5).

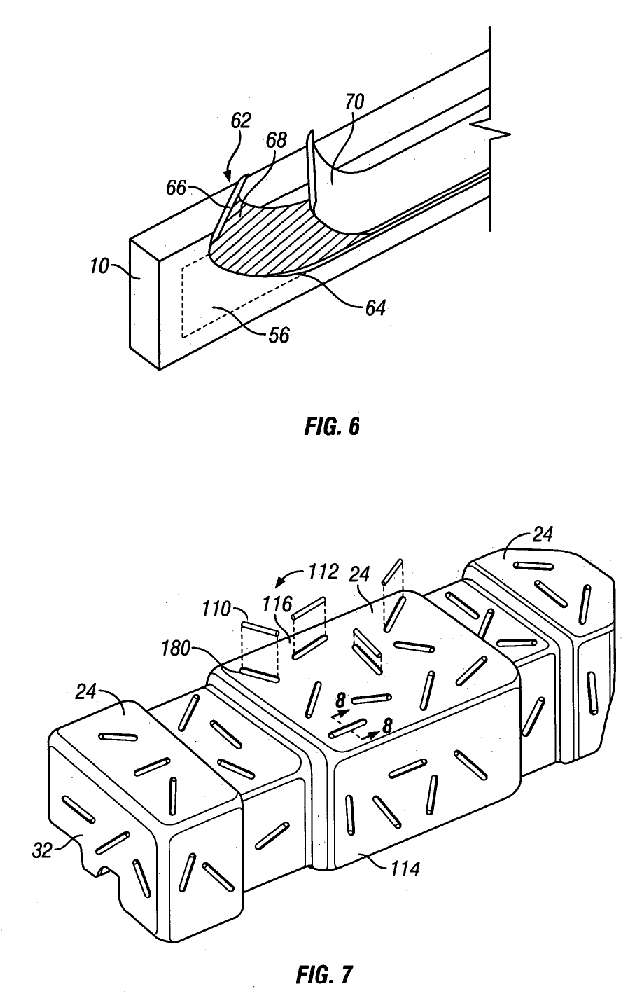

Referring now to FIG. 6, the adhesive 60 may be provided in the form of double-sided tape 62, having a strip of tape material 64 with an adhesive applied to both the first side 66 and second side 68. The first side 66 of the tape 62 may be securely adhered to the joint surface 56 of the cartridge 10. The second side 68 of the tape 62 may be provided with a backing sheet 70 which can easily be removed prior to attachment to the fuel tank 12. An example of an appropriate tape 62 is Automotive Acrylic Plus Attachment Tape, manufactured by 3M, having part numbers 06382, 06383, 06384, and 06386.

Affixing the cartridges 10 to the fuel tank 12 will now be described in greater detail. Before affixing the cartridges 10 to the fuel tank 12, the outer surface 16 of the fuel tank 12, where the cartridges 10 are to be affixed, should first be made clean and dry.

Desirably, the cartridges 10 are of relatively small size as compared to the faces 21 of the tank 12. If the cartridges 10 are affixed to the faces 21 of the tank 12 before the tank 12 is installed in a vehicle, the cartridges 10 can be easily placed wherever the space envelope around the tank 12 permits. To utilize as much of the space envelope as possible, the thickness 52 of the cartridges 10 is kept to a minimum.

Because the cartridges 10 are relatively small compared to the faces 21 of tank 12, it is conveniently possible to attach the cartridges 10 to an assembled tank 12 without need for removal of the tank 12 from a vehicle in which the tank 12 is installed. To do so, the open spaces between fuel tank 12 and adjacent vehicle components should be examined for suitability to accommodate cartridges 10, and for suitability of sufficient space to adhere the cartridges 10 to whatever surface may be available. The backing layer 70 may then be removed from a first cartridge 10, and the exposed adhesive surface 68 may be carefully pressed against outer surface 16 of tank 12 in the desired location.

When working from underneath the tank 12 as installed in a vehicle, it is recommended that the uppermost, or least reachable locations, on the front, rear, and side faces 26, 28, and 30, 32, respectively, of the tank 12 be provided with cartridges 10 first. Working downwards, or to more readily accessible locations, additional cartridges 10 may be attached. Cartridges 10 may be affixed to the bottom face 24 once attachment to the other faces has been completed. As many cartridges may be adhered to the outer surface 16 of tank 12 as space and access allows, and additional cartridges 10 may be affixed to other attached cartridges 10 where possible.

The cartridges 10 may thus be applied to existing fuel tanks 12 either before installation of tanks 12 in corresponding vehicles, or as a retrofit to tanks 12 already installed in vehicles. The orientation of the cartridges 10 on the outer surface 16 of the tank 12 can be random as required to give maximum access and desired surface coverage. The relatively small size of the cartridge 10 compared to the area of the outer surface 16 facilitates the placement of the cartridges 10.

Once affixed to the fuel tank 12 of a vehicle, cartridges 10 may provide protection against collision-related fuel-fed fires in the following manner. In an accident, the fuel tank 12 of a vehicle may be crushed or punctured by objects external or internal to the vehicle to which the tank 12 is attached. Upon damaging the tank 12, any number of cartridges 10 attached to tank 12 may also be damaged, rupturing the casing 40, and releasing the combustion suppressing material 44. The release of the combustion supporting material 44 may extinguish any sparks or flames, and may reduce or eliminate the risk of an intense, fuel-fed fire occurring as a result of the accident.

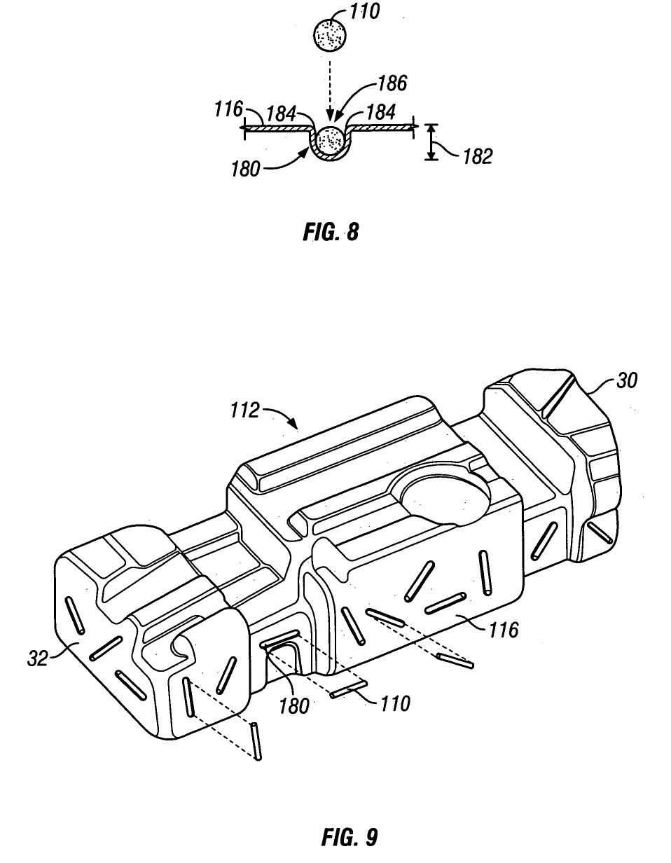

Referring now to FIGS. 7 and 8, an alternative embodiment of the present invention includes a modified fuel tank 112. The modified fuel tank 112 has an outer surface 116, and is provided with recesses 180. The recesses 180 are adapted to receive the cartridges 110. The recesses 180 may extend inwardly from the surface 116 to a depth 182 such that an installed cartridge 110 sits proud of the outer surface 116 of fuel tank 112.

Alternatively, the recesses 182 may have a sufficient depth 182 so that, when installed in recesses 180, the cartridges 110 are flush with, or shy of, the outer surface 116 of fuel tank 112. Providing the cartridges 110 on the fuel tank 112 in such a manner that the cartridges 110 do not protrude beyond the existing outer profile of the tank 112 may be desirable, particularly since such an arrangement may eliminate concerns regarding vehicle component interference under dynamic loads and any possible negative impact on existing vehicle assembly operations.

The cartridges 110 may be secured within the recesses 180 by means of an adhesive 60, such as, for example but not limited to, double sided tape or glue. Alternatively, the cartridges 110 may be secured within the recesses 180 by flexible lips 184 provided at opening 184 of recesses 180, so that the cartridges 110 may be forced past the lips 184 and snapped into position in the recesses 180. In such an embodiment, the cartridges 110 may be provided with a circular cross-section, which may facilitate installation of the cartridges 110 past the lips 184 and into the recesses 180.

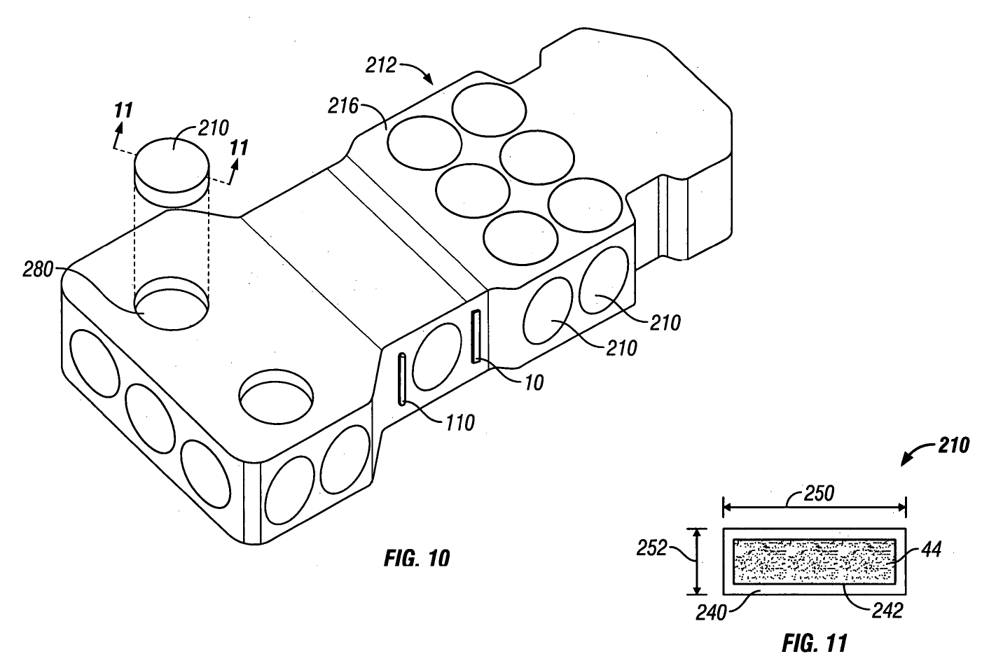

Referring now to FIGS. 10 and 11, a modified cartridge 210 is described. The cartridge 210 is disc-shaped, having a diameter 250 and a thickness 252. The shape of the cartridge 210 may be advantageous in that it has a relatively large cavity 242 in which combustion suppressing material 44 is provided. The cartridges 210 may be affixed to the outer surface 216 of a fuel tank 212 where space and accessibility permit. Alternatively, the cartridges 210 may be received in recesses 280 provided in the outer surface 216 of the tank 212.

While preferred embodiments of the invention have been described herein in detail, it is to be understood that this description is by way of example only, and is not intended to be limiting. The full scope of the invention is to be determined from reference to the appended claims.

1. A combustion suppressing cartridge for attachment to the outer surface of a fuel tank, said cartridge comprising:
a) a casing, said casing defining an internal cavity; and
b) a quantity of combustion suppressing material within said cavity;
wherein said casing is sized and shaped so that a plurality of cartridges may be affixed, in a scattered arrangement, to the outer surface of the fuel tank.

2. The cartridge of claim 1 wherein said casing is sufficiently tough to withstand loads encountered during normal operating conditions, and sufficiently brittle so that said casing ruptures under severe loads.

3. The cartridge of claim 1 wherein said casing is of a generally transparent material.

4. The cartridge of claim 1 wherein said casing comprises a material selected from the group consisting of mineral filled polypropylene, styrenic polymers, polyvinyl chloride, cellulose acetate, polyesters, and mineral filled formulated polyethylene.

5. The cartridge of claim 1 wherein said casing is formed of a multi-layered parison.

6. The cartridge of claim 1 wherein said casing is elongate.

7. The cartridge of claim 6 wherein said casing is generally rectangular in cross-section, having a cross-sectional thickness that is less than the cross-sectional width.

8. The cartridge of claim 6 wherein said casing is generally circular in cross-section.

9. The cartridge of claim 1 wherein said casing is generally disc-shaped.

10. The cartridge of claim 1 wherein said casing comprises a generally flat joint surface to facilitate adhering the cartridge to the fuel tank.

11. The cartridge of claim 1 wherein said combustion suppressing material comprises at least one of the group consisting of sodium bicarbonate, potassium bicarbonate, potassium chloride, ammonium phosphate, and halon.

12. A fuel tank to which a plurality of combustion suppressing cartridges may be attached, said fuel tank comprising:
a) an outer surface; and
b) a plurality of recesses provided in a scattered arrangement in said outer surface, each of said plurality of recesses sized and shaped to receive at least one of the plurality of combustion suppressing cartridges.

13. The fuel tank of claim 12 wherein each recess comprises at least one resilient lip adjacent the outer surface of said tank for engaging said at least one cartridge in snap-fit.

14. In combination, a fuel tank and a plurality of combustion suppressing cartridges, said fuel tank comprising an outer surface, and each of said plurality of combustion suppressing cartridges comprising:
a) a casing surrounding a cavity; and
b) a quantity of combustion suppressing material within said cavity;
c) said casing being sized and shaped so that said plurality of cartridges may be affixed, in a scattered arrangement, to said outer surface of the fuel tank.

15. The combination of claim 14 wherein said outer surface of said fuel tank is provided with a plurality of recesses, each recess being shaped to receive at least one of said plurality of cartridges.

16. The combination of claim 15 wherein each recess comprises at least one resilient lip adjacent the outer surface of said tank for engaging said casing of said cartridge in snap-fit.

17. The combination of claim 15, further comprising an adhesive between the casing of each of said cartridges and the outer surface of said fuel tank.

18. The combination of claim 17 wherein said adhesive comprises a length of double-sided tape.

19. The combination of claim 17, wherein each of said cartridges comprises a generally flat joint surface, and said adhesive is positioned between said joint surface and the outer surface of said fuel tank.
